(19) United States
(12) Patent Application Publication
(10) Pub. No.: US 2006/0206855 A1
(43) Pub. Date: Sep. 14, 2006

(54) System and method for conflict identification and resolution

(76) Inventors: Biju Nair, Long Grove, IL (US); Sumeet S. Paul, Chicago, IL (US); Robert F. Boxall, Elmhurst, IL (US)

Correspondence Address: WELSH & KATZ, LTD, 120 S RIVERSIDE PLAZA, 22ND FLOOR, CHICAGO, IL, 60606, US

(21) Appl. No.: 11/366,155

(22) Filed: Mar. 2, 2006

Related U.S. Application Data
(60) Provisional application No. 60/660,395, filed on Mar. 9, 2005.

(51) Int. Cl. G06F 9/44

(52) U.S. Cl. 717/100; 717/127

(57) ABSTRACT

Systems and methods detect conflicting applications which might interfere with the expected operation of a selected program. Conflicts are managed before they interfere with the operation of the selected program.

### CROSS-REFERENCE TO RELATED APPLICATION

This application claims the benefit of the filing date of U.S. Provisional Application Ser. No. 60/660,395 filed Mar. 9, 2005 and entitled “Conflict Identification and Resolution System and Method” and which is incorporated by reference herein.

### FIELD OF INVENTION

The invention pertains to systems and methods of managing the execution of computer programs. More particularly, the invention pertains to such systems and methods which manage conflicts between programs.

### BACKGROUND OF THE INVENTION

Computer systems include a plurality of programs, or software, to perform the complex functions that users have come to expect. The programs follow a hierarchy which typically includes a Basic Input-Output System (BIOS), an operating system (for example, Windows™), and a plurality of application programs for performing one or more specific functions. Each of these programs requires resources, and managing the conflicting demands for such resources is a major function of modern operating systems. However, in some instances, conflicts may develop between applications, such that one or more of the software applications may not function as expected because another application (or applications) resident on that same PC may be interfering with the intended software application.

For clarity, the application or client that the user wishes to run is referred to herein as the friendly application (FA) and the application or client that interferes with the performance of the FA will be referred to herein as the conflicting application (CA). There are various reasons why the programs interfere with one another. Such interference may be happening due to:

(a) Another software application and/or driver competing with the FA for a hardware resource or port on the PC; or

(b) An undesired application, such as virus or other malicious code may have penetrated the PC, past any protection offered by the PC.

The first category can particularly occur when later installed software includes the same functionality as the functionality offered by the FA. It will be appreciated that the similar functionalities may be only a small subset of the respective functionalities of the FA and later installed program. The CA may, but need not, be associated with newly installed hardware. Computer viruses or similar malicious code can operate in a similar manner.

It is also important to note that FAs may not be aware of new CAs that may come along after the FA has been developed or deployed. As a result, existence of such CAs can be a major distraction to the end user, not to mention a major service interruption or support burden for the provider of the FA.

Therefore, there are continuing needs for systems and methods that can detect CAs which will interfere with the expected operation of a FA. Furthermore, systems or methods are needed that will detect and disable malicious applications that get past an existing virus detection and protection software system.

### BRIEF DESCRIPTION OF THE DRAWINGS

FIG. 1 is a block diagram of a system that embodies the invention;

FIG. 2 is a flow diagram of a method which embodies the invention;

FIG. 3 is a flow diagram of an alternate method which embodies the invention; and

FIG. 4 is a flow diagram further illustrating selected steps of methods in accordance with the invention.

### DETAILED DESCRIPTION OF THE INVENTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In one aspect of the present invention a mechanism is provided that will update a list of CAs on the end user's machine. A related aspect provides an ability to “inform” the FA about each newly installed CA. An additional aspect provides a system and method for resolving the conflicts which may occur between the FA and the CAs.

Further, in an embodiment of the present invention, systems and methods are provided that will prevent the occurrence of such service or product disruption by discovering and resolving identifiable CAs. Respective software can be integrated into a selected product.

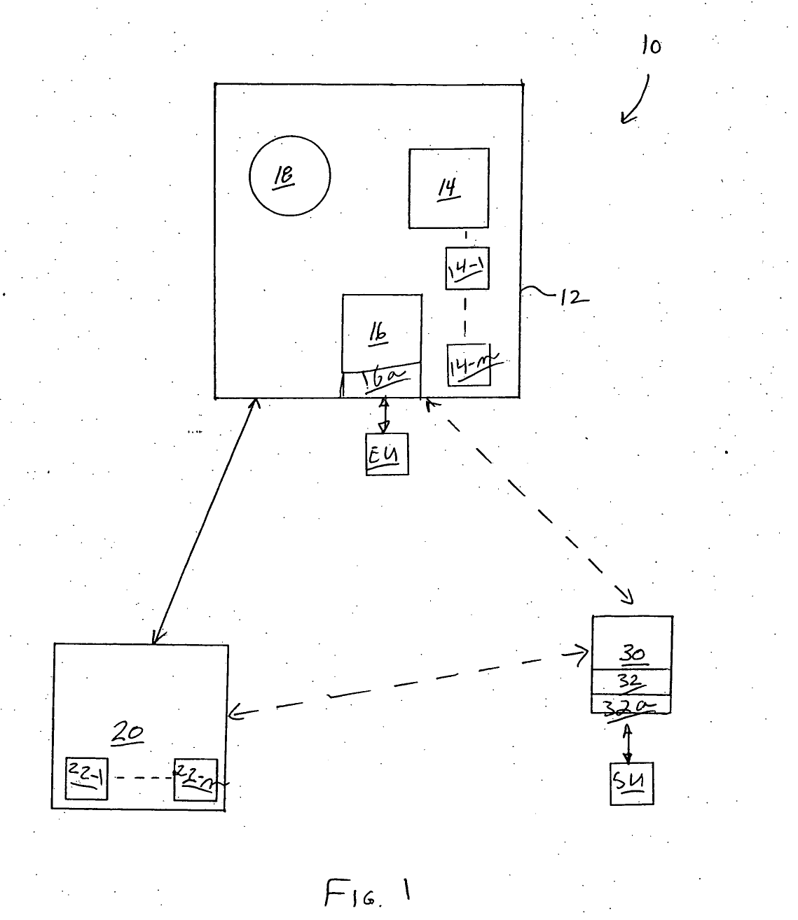

Referring now to FIG. 1, a system 10 includes a computer 12 with at least one client software application 14, such as an executable file or a driver program, which may be regarded hereinafter as a Friendly Application (FA). In one arrangement, the FA 14 has embedded herein a conflict detection program 16 in accordance with the present invention. Alternatively, as discussed in greater detail hereinafter, the conflict detection program 16 may be an independent program separate from the FA 14.

In some embodiments of the invention program 16 can communicate conflict resolution recommendations via a graphical user interface 16a to an end user EU. In such instances, as discussed subsequently, the end user EU would make the final resolution decision.

The present invention addresses a situation where the user of the system 10 introduces or adds a new client or software application, which is referred to herein as a conflicting application (CA) 18. Both the CA 18 and the FA 14 compete for access to the resources of the computer 12 that is part of the system 10. Although not specifically shown, in at least some instances other CA reside on the computer 12, just as multiple FA 14-1, 2 - - - n may reside on a user's computer. Additionally, the computer 12 may alternatively be coupled to the computer 20, which can include other programs, drivers, routines, or, applications 22-1 - - - n that require access to the resources of the computer 12. Thus, there may be other CA 18 resident on the computer 20 that are part of the system 10.

The computers 12 and 20 may also be coupled to a server 30. The server 30 can include a conflict detection client 32 in accordance herewith that provides conflict detection and resolution services as well as the latest updates for conflict definitions. In embodiments where there is no conflict detection client or program resident on the computer 12, the computer 12 will receive its conflict detection services from the resource 32 available at the server 30. Additionally, as needed the server 30 can provide updates to the conflict detection program 16 resident on the computer 12 or to other stand alone clients which might be resident on computers or other computers that server 30 interacts with.

Server 30 in embodiments where client 32 is providing conflict management services to other programs resident on system 10, or other processors, can incorporate a graphical user interface 32a whereby a supervisory user or manager SU can interact with client 32. The supervisory user SU can act on recommendations or other information from manager 32 to direct a shut down of one or more conflicting programs or virus-type programs on one or a plurality of processors.

During operation, a FA may at some point become a CA with respect to another FA. This can occur either manually, based on data known to the user or system provider, or automatically as the result of various as the result of the various detection techniques described hereinafter. As one example, the detection techniques can detect a previously friendly application as a conflicting application when the previous FA begins using data and/or resources needed by the application calling the Conflict Manager, such as programs 16 or 32, of the present invention. In response, the detection program 16 residing on the computer 12 treats the FA as a CA with respect to the new FA requesting the resources of the system 10. The system 10 would instruct the detection program 16 to treat the FA 14 as a CA 18 and allocate system resources accordingly.

As indicated above, the various software applications or clients installed on a computer system compete for the resources of that system. Accordingly, legitimate applications or clients, such as those that are bundled as a part of a hardware bundle may be considered a CA in some circumstances. Depending upon the sophistication level of the CA, the system of the present invention can provide multiple methods to deal with the CA.

In one embodiment of the present invention, the application or client that is the CA can simply be terminated. In another embodiment, the CA is put in a “suspended” mode.

In yet another embodiment, if the application is equipped with a set of APIs that permit other applications to interact with it, then embodiments of the present invention will switch the CA into a dormant state, where the CA does not have active control of hardware resources. Once the conflict situation no longer exists, the system will restore the CA to its original state. The CA is restored either when the FA terminates/exists or when so desired by the user.

In one embodiment of the present invention, the detection program 16 is configured as a separate or stand-alone client or program that is resident on the computer 12. In an alternative embodiment, the detection program 16 is an integral part of the program or device that is later added to the computer 12 and part of the FA.

In the following explanation reference is made to the detection of a CA 18. In accordance with the teachings of the present invention there are various methods for determining the type of conflict. Any number or combination of the following methods can be used to identify conflicting applications:

1. Detection by Process Executable: the process executable name (ie start.exe) are explicitly dictated and can be later updated. By enumerating the running processes within the system the conflict manager is able to identify matching processes.

2. Detection by Partial Process Executable: detection is done by using partial exe names (ie *start.exe).

3. Detection by Process Location: detection is done by using the location of the executable on the system (ie C:\Program Files\Cisco\Aironet)

4. Detection by Partial Process Location: detection can also be done by using the partial location of the executable on the system (ie “Cisco\Aironet”)

5. Detection by Process Title: detection can be done by enumerating all window handles on the system and comparing the names of the windows against known CA window names.

6. Detection by Partial Process Title: detection can also be done by doing partial string matching of the title window. This is especially useful in that most CAs have variable contents in their window titles.

7. Detection by Service Name: enumerating and identifying services by service name and matching against a known CA service name in at least some instances, these conflicting services may be identified through manual testing and knowledge of the resources used by the calling application.

8. Detection by registry Location: explicit search and identification of known conflicting registry values.

9. Detection by AutoStart Location: explicit search and identification of items stored in several locations with in the various Operating Systems auto-start locations.

10. Detection by Process Data Activation: the system recognizes, at run time, various services, executables, and other programs that might conflict with its use of particular system hardware or software resources. As one example, such detection may be made by watching a particular resource, such as a COM port. When that port is activated, the process watching that port can simultaneously monitor a variety of items, including CPU usage per process and open handles per process. In addition, the monitoring process can also ask the operating system to identify the specific process that has requested access to that particular Hardware Port (for example Com Port). Using that information, the application that is running in that process can be determined and thereby enough information can be collected to identify it to the end user in a fashion that the end user can understand sufficiently that the user can decide to terminate that application, if necessary.

When retrieving direct information about the use of a Hardware Port, two methods of detection as available. One method of detection is by resource assignment through the OS. The underlying OS is queried for the process which is currently accessing a port. Alternately, detection can be by establishing handle assignment. The access handle which is currently using the port in question may be retrievable. At that point, the program can request for each process a list of all owned handles. The owning process can be identified by matching those two values.

For resources and processes other than Hardware Ports, the OS may be able to determine what program or process requested access to the item. In such instances, a decision can be based on the change in processor usage associated with the activation of that resource and other statistical methods. Regardless of the method used, the detection program identifies the offending resource necessary and causes that resource to be exercised by inducing the target resource to passively transit data. In the case of a hardware resource this includes the active transmission of data to or from the device through the standard OS access mechanism. In the case of a software resource this typically involves the explicit attempt to activate the resource. While attempting that access the conflict manager of the present invention watches for activity within each process. By identifying processes which have activity spikes when access/activation mechanisms are employed, a recommendation can be provided in determining a potential conflicting application. At this point the conflict manager can either automatically shut down the conflict or prompt the end user EU to confirm or override the selection made. Because the identification can be carried out by statistical methods for at least some of the techniques described herein, the detection program of the present invention may be configured to present recommendations to the end user EU with a specific degree of confidence, rather than as an absolute fact. If a recommendation is made, the end user EU will typically make the final decision.

11. Detection by Deterministic Process selection: the conflict manager such as program 16 or 32, can do a systematic search of all processes, shutting down each CA one at a time, while attempting to access the resource in question, until no interoperability problems occur. Once the CA has been isolated it can be marked to be automatically shutdown using options 1-9, as set forth above.

As indicated above, all or any number of the foregoing detection methods can be incorporated into a detection program. Thus, when the detection program searches for CAs using the numerous detection criteria, it is highly probable that a program identified as a CA will be identified as a CA by more than just one detection criterion because it matches multiple detection criteria. Accordingly, the detection program such as 16, 32 will preferably check before attempting to shut down or otherwise affect the function of each CA to make sure it has not already been acted upon by another or the detection processes of the present invention.

In at least some embodiments of the present invention, information about conflicts and various CAs can be stored in a format that groups related CAs together in logical and easy to understand groups for the maintainer of the data.

Representative application information can be stored in various data formats, for example by using an XML file. Information can include, without limitation, Name, Process EXE, Technology, target Operating System and the like all without limitation.

The CAs can be grouped into these segments by the items with which they are deployed or distributed. These are all grouped under the same heading so that the end user EU can easily identify multiple items as being associated with a single real world item.

In one embodiment, the conflicting client server (CCS), such as the server 30, of the present invention can be programmed to forward the updated data to clients as soon as they request updates. It will be appreciated that a CCS is simply a convenient reference for a functionality, and a separate server is not required.

Rather, a CCS is just an example of any backend server, such as server 30, supplying data to the Conflict Manager function, such as programs 16,32. It will also be appreciated that no such server function is required at all for many aspects of the invention to operate successfully.

The conflicting client server could be used whenever an application would want to update the list of conflicts over time. If the particular implementation is designed to have a static list of conflicts then no server is necessary. Additionally, when using the detection techniques 10 and 11, above, a server could be used to share information learned from one end user PC/computer with all other PCs/Computers configured to get updates. This enables the system to learn and share that learning with others over time.

In other embodiments, a CCS is able to send information to update the system with the conflict manager by encoding the necessary information for multiple conflicting items. Each conflict item is marked by the target Operating System, which is used by the calling applications to identify which conflict groups they need resolved. For example, an application may request that all conflicts for Group X be resolved on the current machine or system.

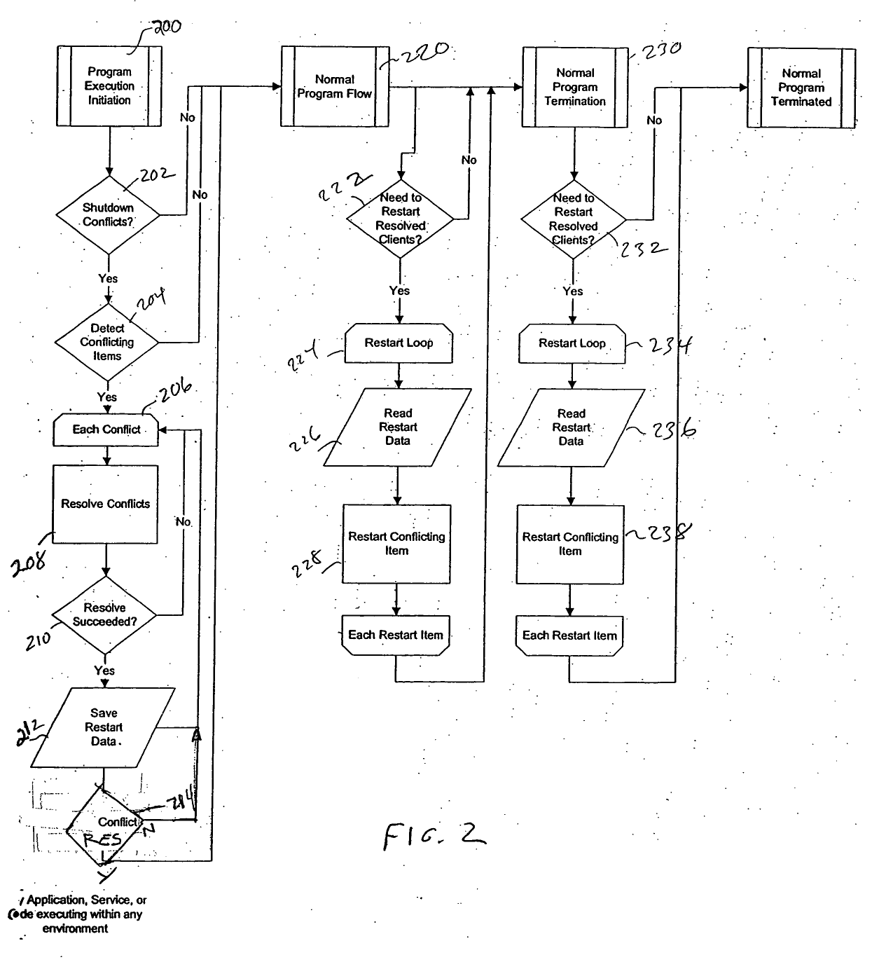

Referring now to FIG. 2, the operation of one embodiment is shown wherein the detection program is part of the FA, or what will sometimes herein be referred to as an embedded detection program. The process of detecting and resolving resource conflicts between CA and FA begins at step 200 with the initiation or the execution of the FA.

At step 202, the calling application makes a decision of when, and whether, to check for conflicting applications. This is particularly useful if, for example, the implementation includes a database of conflicting application data, but is not needed in all implementations. If not, then the process proceeds to the normal flow of the FA as shown at step 220.

Alternately, where conflicts are to be evaluated, the process flows to step 204 to detect conflicting items or CA using the various above described detection criteria. The process then proceeds to step 206 where the CAs needing to be resolved are identified using for example, the methods 1-10 discussed above.

In some embodiments, although not all, the order in which the CAs are resolved may be prioritized. This is best achieved when the details of all of the conflicting applications are known, such as through reverse engineering the conflicting applications by hand, or by communicating with their developers.

At step 208, the first of the identified conflicts is resolved according to process associated with the conflict detection criteria. The detection program signals the Operating Systems' Application Manager and sends a request to terminate the conflicting process, thereby causing the Applications Manager to shut down the CA and free up system resources to allow the FA to continue operating.

Once the conflict resolution technique associated with that detection criteria has been applied, the process proceeds to step 210 to determine if the conflict was resolved. If not, the process loops back to step 206 to attempt to resolve the conflict through another resolution technique. The process advances through steps 208 and 210 as discussed above. The process continues to loop until each conflict resolution technique for that conflict has been applied.

Once the conflict has successfully been resolved, the process advances to step 212 to determine whether restart data must be saved for the conflicting application. In step 212 restart information associated with the CA is stored so that the CA application can be restarted from its current state once the FA no longer needs the system resources.

At step 214, it is determined if each of the conflicts has been resolved. If all conflicts have been resolved, then the process continues at step 220. If not, then the process returns to step 206 so that the next conflict application can be selected and addressed. It will be appreciated that step 204 can include one or more CAs, and steps 206-214 are performed for each CA in that list. Thus, at step 214, if the list includes another CA which has not yet been shut down, the process of the present invention will loop back to step 206.

It will be appreciated that the normal flow of a given FA may permit certain CA's to be restarted at an intermediate state of the normal flow of the FA, before the FA process reaches normal termination. In such an instance, after the normal flow of the FA at 220, the conflict detection program signals the system resources to determine, at step 222, if the halted or resolved CA needs to be restarted. If not, then the normal flow of the process continues to normal program termination at step 230.

When there are CA that require restarting, then at step 224 the detection program selects the CA to be restarted and enters the restart loop. At step 226, the system retrieves the restart data fropm memory and at step 228 restarts the previously affected CA. It will be appreciated that the nature of the restart may vary depending on the particular conflict resolution technique applied to that CA.

Some CAs will be restarted only after normal termination of the FA. For such CA's after normal termination of the FA at step 230, at step 232 the detection program determines if there are any halted CAs. If not, then the FA is terminated at 240. If there are applications that need to be restarted, the at step 234 the conflict detection program begins the restart loop. At step 236 the system retrieves the restart information from memory. At step 238, the conflicting item is restarted and allowed access to system resources. The process then continues to termination of the FA.

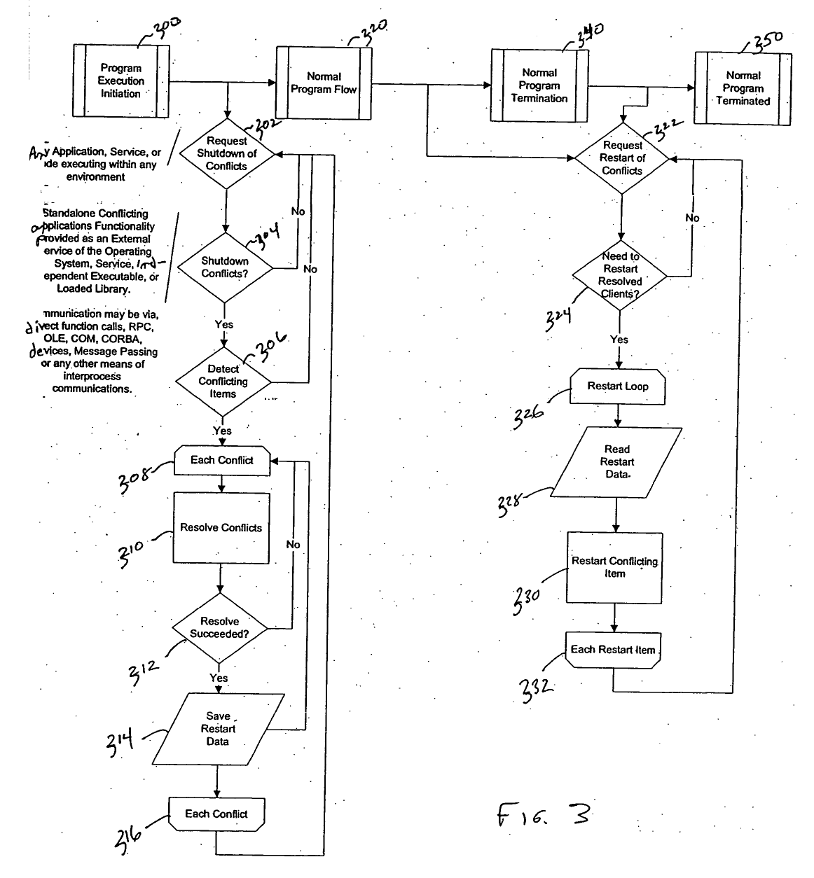

Referring now to FIG. 3, in an alternative embodiment the entire conflicting application manager concept can also be run as a standalone service or external executable such as for use by program 32, multiplied external requesters using message passing or any other standard means of communication. This allows for a single repository for application management to be shared across all system items. Thus, in such embodiments, the conflict detection programs, such as program 32, is a free-standing or an external application relative to the operating system of the system. This implementation has broad application, including, for example, as an anti-virus solution.

The process begins at step 300 with the initiation or the execution of the FA or program. At step 302 it is determined if the detection program has detected a conflict between a FA and a CA and, hence, has requested a shutdown or suspension of the conflicting application or other type of program. If there is no request, then the program continues with normal program flow at 320 and there is no CA that needs to be shut down or suspended.

If the detection program requests that the CA be shut down, the normal program can continue while the shut down process is initiated. Alternatively, if the detection program requests a shut down of the CA, then the normal program can be paused while the shut down process is completed.

At step 304, the detection program signals the system to determine if the conflict should be shut down or suspended. If the CA can not be shut down or suspended, then the process returns to step 302 to await the next request to shut down or suspend a conflicting application or program.

On the other hand, if it is determined that the conflicting application can be shut down or suspended, then at step 306 conflicting programs are detected in accordance with the exemplary methods 1-10 discussed above. At step 308 each conflict associated with a CA is identified.

At step 310 the conflict detection program resolves the conflict. Depending on what information is available, various steps can be taken to resolve a conflict. For example, it may be possible to place the CA in a state that it no longer causes a conflict, such as by going dormant. In cases where the steps require more than just shutting it down, those steps are specific to that CA.

At step 312, the conflict detection program determines if the conflict was successfully resolved. If the conflict is successfully resolved, at step 314 the restart data is saved to memory and at step 316 the process returns to await the next request for conflict resolution. If not, then the process returns to step 308 where the next conflict is again attempted to be resolved. If the conflict is not resolved, one or more additional attempts may be made.

In one exemplary implementation, three attempts can be made to resolve the conflict. After three failed attempts, a message can be sent to the user SU by means of a message box, that the conflict cold not be resolved. Depending on the implementation, the program may then be allowed to continue, or to be terminated, or to give the user SU the choice. In some implementations, the caller of the conflict manager can decide before beginning the process of conflict resolution whether to try forever or try N times, and also whether to stop if any resolutions fail.

Before and after the program termination at 340, the conflict detection program such as program 32, determines, at step 322, if there are any requests for restart of a CA that was previously shut down. If there are no restart requests, then the process continues to normally terminate the program. If the conflict detection program requests a restart, then at step 324 the conflict detection program determines if there are any outstanding, suspended or halted clients that need to be restarted. If not, then the process returns to step 322 to await the next request to restart a CA.

If at step 324 the system determines that there are CA the need to be restarted, then at step 326 the restart loop is initiated automatically by the system or because the user has requested it. At step 328, the conflict detection program reads the restart data or information from memory. At step 330, the Conflict Manager initiates the restart of the conflicting item or CA and the CA is restarted using the restart data read from memory.

At step 332, the CA is restarted and the process returns to step 322 to await the next restart request. For certain CAs in some implementations, “restart” can be understand to mean “reverse,” so that if any item was resolved by making it dormant, it is made undormant instead of restarting it.

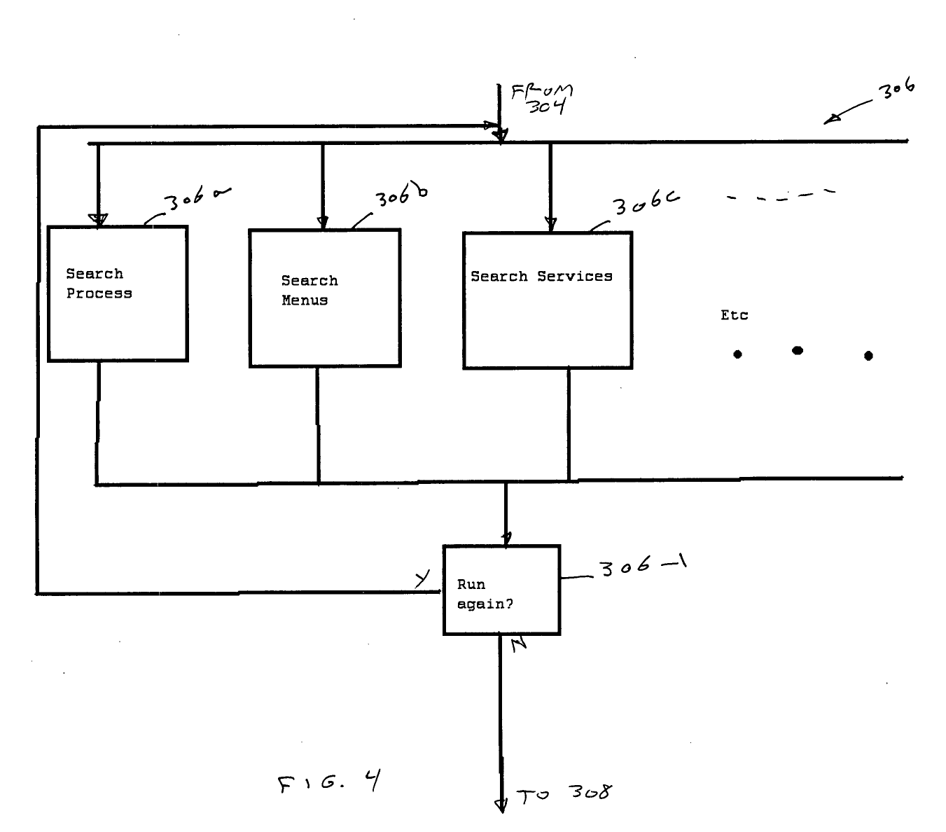

FIG. 4 illustrates in more detail aspects of processing step 306 “Detect Conflicting Items”. Relative to the above enumerated identification methods, various searches can be carried out such as, search process 306a, search menus 306b, search services 306c . . . The order of the various types of searches is configurable. They can be run sequentially or simultaneously. The “Run again” decision 306-1 is made in response to items that have been found since in some cases it is necessary to first identify one item before then looking for a specific set of related items.

The detection program or client 32 can also be used to detect virus or other similar programs that may be executed on the system. When the virus scanning software fails and the virus manages to break the defense of the scanning software, there is very little the virus scanner can do to fix it. The conflict detection program can detect such a violation and enable an IT manager such as user SU to immediately dispatch, via the update mechanism described above, an instruction to the system to “shutdown” a named application or other program on all machines immediately.

In another aspect of the present invention the clients that are intended to reside on the system can be registered with the server 30 upon startup so that the system can be notified in real time of any new threats. In this way, the malicious applications can be detected in real time and, thus, a real time defense exists against malicious applications.

In accordance with the above, when a malicious or virtual application (VA) gets past the detection of a virus detection application, the VA will most likely be executed and become a program or application that will demand system resources. Such a demand will cause a conflict and be in violation of the resource demands of the FA.

In the event that such a violation occurs, then the conflict detection program 32 can alert the IT manager, user SU, to immediately dispatch instructions to shutdown the named VA on all machines immediately. In alternative embodiments, the conflict program 32 can detect and be set-up to automatically shut down the VA and provide a notice to the IT manager instead of alerting the IT manager that there is a conflict.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method comprising:
initiating execution of a selected program;
determining that conflicting programs are to be detected, and detecting any such conflicting programs.

2. A method as in claim 1 where conflicting programs are placed, at least temporarily, into a non-conflicting state.

3. A method as in claim 2 where the non-conflicting state is selected from a class which includes at least terminating a conflicting program and suspending a conflicting program for subsequent restart.

4. A method as in claim 3 where suspending includes storing restart information.

5. A method as in claim 4 which includes restarting a suspended program subsequent to resolving a conflict.

6. A method as in claim 2 where a previously conflicting program, no longer conflicting, is executed.

7. A method as in claim 6 where in the absence of the previously detected conflict at least one of the conflicting programs is executed prior to termination of the selected program.

8. A method as in claim 2 where, in the absence of a plurality of previously detected conflicts, respective ones of the previously detected conflicting programs are executed prior to the termination of the selected program.

9. A method as in claim 1 where detecting includes at least one of detecting by enumerating executing processes, detecting by locating executable processes, detecting by enumerating selected titles, detecting by enumerating services, detecting by registry location, detecting by searching or identifying items stored in selected locations, detecting by evaluating resource usage or detecting by conducting searches of selected processes.

10. A method as in claim 6 where detecting includes detecting by enumerating executing processes, detecting by locating executable processes, detecting by enumerating selected titles, detecting by enumerating services, detecting by registry location, detecting by searching or identifying items stored in selected locations, detecting by evaluating resource usage or detecting by conducting searches of selected processes.

11. An apparatus comprising:
at least one processor that executes programs;
a plurality of programs executable by the at least one processor; and
conflicts management software which detects the presence of conflicts between at least one member of the plurality and other members thereof.

12. An apparatus as in claim 11 wherein the management software includes instructions to carry out an iterative process that uses a plurality of criteria to evaluate conflicts between the one member and other members of the plurality.

13. An apparatus as in claim 12 which includes additional software to maintain a file of conflicting programs.

14. An apparatus as in claim 12 which includes additional software to communicate an indicator to the at least one member of the plurality as to the detected presence of at least one conflicting program.

15. An apparatus as in claim 12 where the instructions implement the plurality of criteria which includes detecting by enumerating executing processes, detecting by locating of executable processes, detecting by enumerating, selected titles, detecting by enumerating services, detecting by registry location, detecting by searching or identifying items stored in selected locations, detecting by evaluating resource usage or detecting by conducting searches of selected processes.

16. An apparatus as in claim 12 which includes software for visually presenting information relative to detected conflicts.

17. An apparatus as in claim 12 which includes further instructions to address a detected conflict arising out of at least the one of the other members of the plurality.

18. An apparatus as in claim 17 which includes additional instructions to evaluate if the conflict had previously been addressed.

19. An apparatus as in claim 18 where the additional instructions address the detected conflict by one of terminating the conflicting one member of the plurality, by suspending the conflicting one of member of the plurality, or, making a recommendation as to termination or suspension.

20. An apparatus as in claim 19 where the management software includes restart instructions which responsive to a predetermined criterion to restart a suspended program.

21. An apparatus as in claim 12 which includes at least two coupled processors with the management software executed on one processor and with at least some of the programs executed on the other processor.

22. An apparatus as in claim 12 where the management software displays a list of conflicts.

23. An apparatus as in claim 22 which includes instructions to shut down or suspend a conflicting program.

24. An apparatus as in claim 23 which includes activation of instructions to shut down or suspend the conflicting program.

25. Software recorded on a computer readable medium, the software comprising:
first software that establishes that at least one conflict has been detected between first and second programs; and
second software that carries out an iterative resolution of the at least one conflict between the first and second programs.

26. Software as in claim 25 which includes software enabling execution of the first program once the at least one conflict with the second program has been resolved.

27. Software as in claim 25 which includes another program in which the first and second software are incorporated.

28. Software as in claim 25 which includes another program which is coupled by communication software with at least the first software.

29. A system comprising:
an apparatus which communicates with a plurality of different devices, the devices execute different programs, the apparatus identifies and resolves conflicts, via an iterative process, between at least one of the programs and another program.

30. A system as in claim 29 where the apparatus includes a server which provides conflicts management services to members of the plurality of devices.

31. A system as in claim 30 where at least some of the members of the plurality are displaced from the apparatus.

32. A system as in claim 29 where the apparatus maintains a list of conflicting programs.

33. A system as in claim 29 where the apparatus includes a user interface and circuitry that presents conflict related information via the interface for user evaluation.

34. A system as in claim 29 where the apparatus, in response to a detected conflict, suspends or terminates the another program enabling the at least one program to execute.

35. A system as in claim 34 where the apparatus restarts a suspended program in the absence of the detected conflict.

36. A system as in claim 29 where the iterative process includes at least one of enumerating executing processes, locating executable processes, enumerating selected titles, enumerating services, searching or identifying items stored in selected locations, evaluating resource usage or conducting searches of selected processes.
